(19) United States
(12) Patent Application Publication
(10) Pub. No.: US 2023/0287707 A1
(43) Pub. Date: Sep. 14, 2023

(54) LOCK ASSEMBLY

(71) Applicant: QuB LLC, Lake Elmo, MN (US)

(72) Inventors: Frank W. Campbell, Tucson, AZ (US); John J. Micinski, Belvidere, IL (US)

(73) Assignee: QuB LLC, Lake Elmo, MN (US)

(21) Appl. No.: 17/690,196

(22) Filed: Mar. 9, 2022

(51) Int. Cl. E05B 47/00; E05C 9/02

(52) U.S. Cl. CPC E05B 47/0012; E05C 9/028; E05B 2047/0017; E05B 2047/002; E05B 2047/0023; E05C 9/006

(57) ABSTRACT

A lock assembly comprises a driving member, a drive assembly, and an engaging member. The drive assembly comprises a drive connector operatively connected to the driving member, a lead screw operatively connected to the drive connector, a carriage configured and arranged to move along the lead screw, and an elongate member operatively connected to the carriage. The driving member is configured and arranged to rotate the drive connector, and the drive connector is configured and arranged to rotate the lead screw. Rotation of the lead screw moves the carriage along the lead screw and the elongate member moves with the carriage between locked and unlocked positions. The engaging member is configured and arranged to selectively engage the elongate member in the locked position.

### BACKGROUND

This invention relates generally to a lock assembly and, more particularly, to a lock assembly that utilizes an elongate member to move between a locked position and an unlocked position. The lock assembly is preferably electronically operated and is preferably configured and arranged to be operated via an electronic device such as a mobile App. The lock assembly can be used with a casement window having an electronic operating assembly for opening or closing the window sash relative to the window frame. The lock assembly can be used with any suitable window, cabinet, or support structure that is desired to be selectively locked.

For the reasons stated above and for other reasons stated below, which will become apparent to those skilled in the art upon reading and understanding the present specification, there is a need in the art for such a lock assembly.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, a lock assembly comprises a driving member, a drive assembly, and an engaging member. The drive assembly comprises a drive connector operatively connected to the driving member, a lead screw operatively connected to the drive connector, a carriage configured and arranged to move along the lead screw, and an elongate member operatively connected to the carriage. The driving member is configured and arranged to rotate the drive connector, and the drive connector is configured and arranged to rotate the lead screw. Rotation of the lead screw moves the carriage along the lead screw and the elongate member moves with the carriage between locked and unlocked positions. The engaging member is configured and arranged to selectively engage the elongate member in the locked position.

In one embodiment, a lock assembly comprises a motor assembly, a drive assembly, and an engaging member. The motor assembly comprises a motor operatively connected to a motor gear assembly. The motor gear assembly includes a worm, a worm gear, and a motor connector. The motor is configured and arranged to rotate the worm, the worm is configured and arranged to rotate the worm gear, and the worm gear is configured and arranged to rotate the motor connector. The drive assembly comprises a drive connector operatively connected to the motor connector, a lead screw operatively connected to the drive connector, a carriage configured and arranged to move along the lead screw, and an elongate member operatively connected to the carriage. The motor connector is configured and arranged to rotate the drive connector, and the drive connector is configured and arranged to rotate the lead screw. Rotation of the lead screw moves the carriage along the lead screw and the elongate member moves with the carriage between locked and unlocked positions. The engaging member is configured and arranged to selectively engage the elongate member in the locked position.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a perspective view of an embodiment lock assembly constructed in accordance with the principles of the present invention;

FIG. 2 is a perspective view of a motor assembly and a drive assembly of the lock assembly shown in FIG. 1;

FIG. 3 is a perspective view of the motor assembly shown in FIGS. 1 and 2;

FIG. 4 is a perspective view of the motor assembly shown in FIG. 3 with a cover removed;

FIG. 5 is a perspective view of the drive assembly shown in FIGS. 1 and 2;

FIG. 6 is an exploded perspective view of the drive assembly shown in FIG. 5;

FIG. 7 is a perspective view of a lock nut of the drive assembly shown in FIG. 6;

FIG. 8 is a top view of the lock nut shown in FIG. 7;

FIG. 9 is a bottom view of the lock nut shown in FIG. 7;

FIG. 10 is a perspective view of the drive assembly shown in FIG. 5 with the cover removed in a locked position;

FIG. 11 is a perspective view of the drive assembly shown in FIG. 10 in an unlocked position;

FIG. 12 is a perspective view of the lock assembly shown in FIG. 1 operatively connected to a window in a locked position;

FIG. 13 is a perspective view of the lock assembly operatively connected to the window shown in FIG. 12 with the cover removed from the drive assembly;

FIG. 14 is a perspective view of the lock assembly shown in FIG. 1 operatively connected to the window in another locked position;

FIG. 15 is a perspective view of the lock assembly operatively connected to the window shown in FIG. 14;

FIG. 16 is a perspective view of the lock assembly operatively connected to the window shown in FIG. 14 with the cover removed from the drive assembly;

FIG. 17 is a perspective view of the lock assembly shown in FIG. 1 operatively connected to the window in an unlocked position;

FIG. 18 is a perspective view of the lock assembly operatively connected to the window shown in FIG. 17 with the cover removed from the drive assembly;

FIG. 19 is a perspective view of the lock assembly shown in FIG. 1 operatively connected to a window, the lock assembly being in an unlocked position and the window being in a closed position;

FIG. 20 is a perspective view of the lock assembly operatively connected to the window shown in FIG. 19 with the window in a partially open position;

FIG. 21 is a perspective view of the lock assembly operatively connected to the window shown in FIG. 19 with the window in another partially open position;

FIG. 22 is a perspective view of the lock assembly operatively connected to the window shown in FIG. 19 with the window in a fully open position;

FIG. 23 is a perspective view of the lock assembly shown in FIG. 1 operatively connected to a window;

FIG. 24 is a perspective view of a portion of the lock assembly shown in FIG. 12 with the motor assembly removed; and

FIG. 25 is a perspective view of a portion of the lock assembly shown in FIG. 12.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

Embodiments of the disclosure generally provide a lock assembly that can be used with any suitable window, cabinet, or support structure that is desired to be selectively locked.

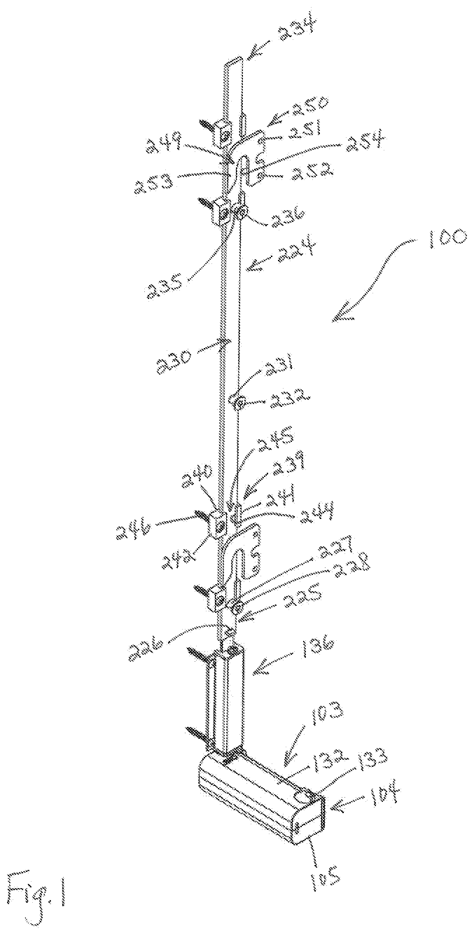

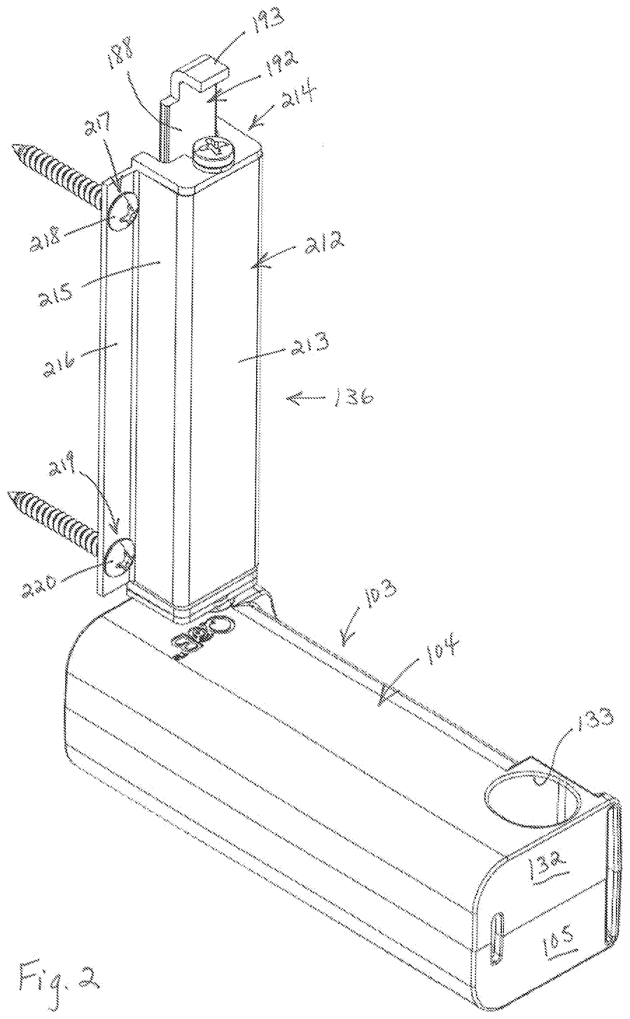

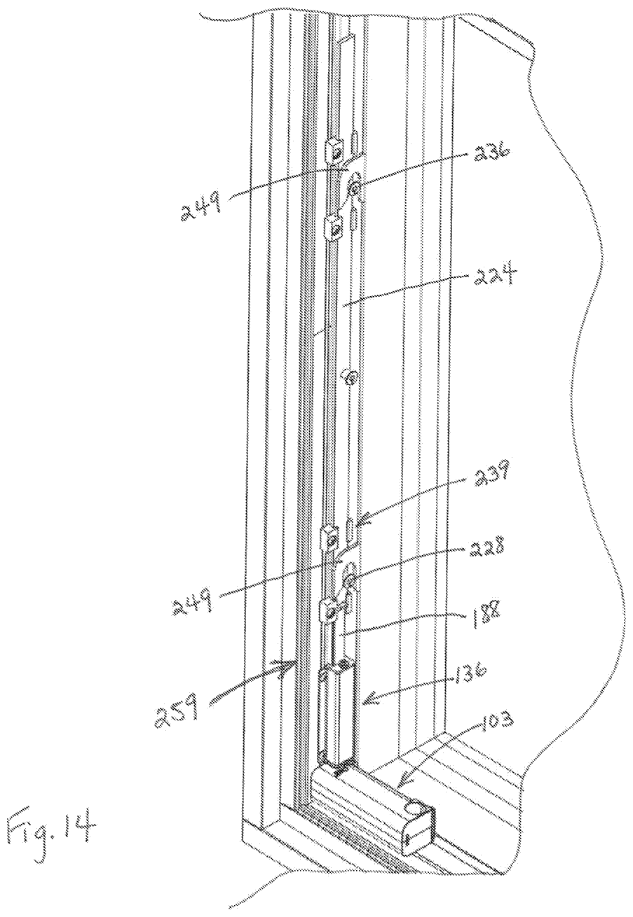

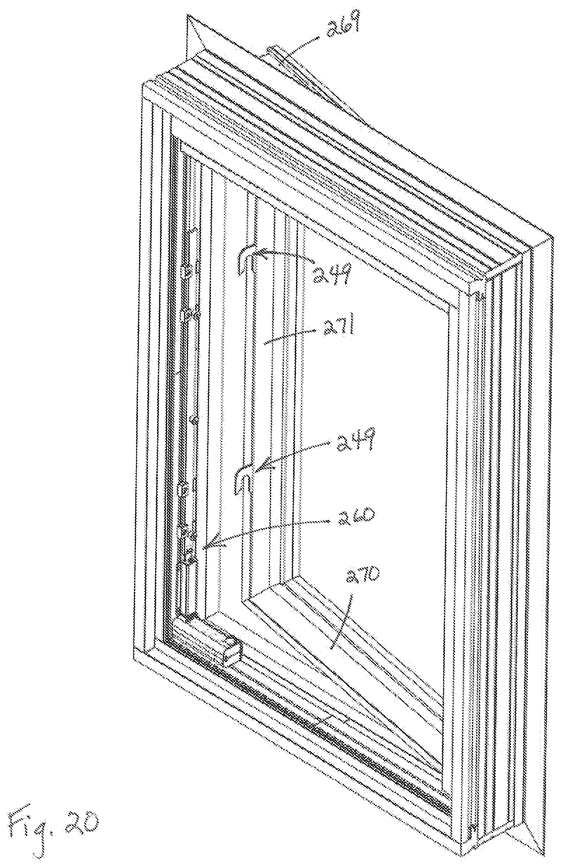

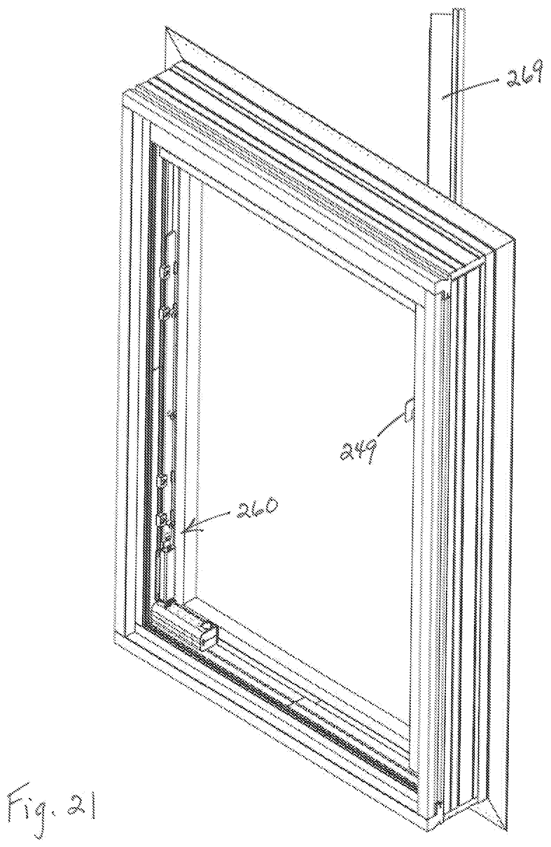

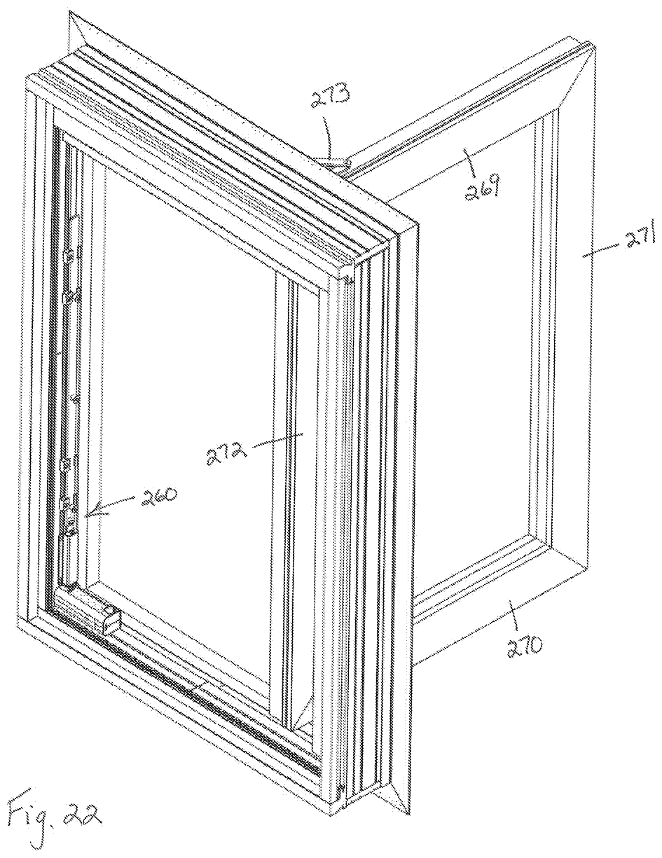

In one embodiment, illustrated in FIGS. 1, 12, 14, 17, and 19-22, a lock assembly 100 generally includes a driving member 118, a drive assembly 136, and an engaging member 249. Generally, the driving member 118 is configured and arranged to rotate a portion of the drive assembly 136, which is configured and arranged to move between locked and unlocked positions to selectively engage the engaging member 249. The drive assembly 136 is operatively connected to one of a stationary portion or a movable portion and the engaging member 249 is operatively connected to the other of the stationary portion or the movable portion. In this embodiment, the drive assembly 136 is shown operatively connected to the stationary portion (e.g., window frame) and the engaging member 249 is shown operatively connected to the movable portion (e.g., window sash). Although a casement window is shown, it is recognized that an awning window, a sliding window, or other suitable support structures could be used with the lock assembly 100. When the window is positioned in a closed position, the drive assembly 136 can be moved between the locked and unlocked positions to selectively engage and disengage the movable portion relative to the stationary portion via the engaging member 249.

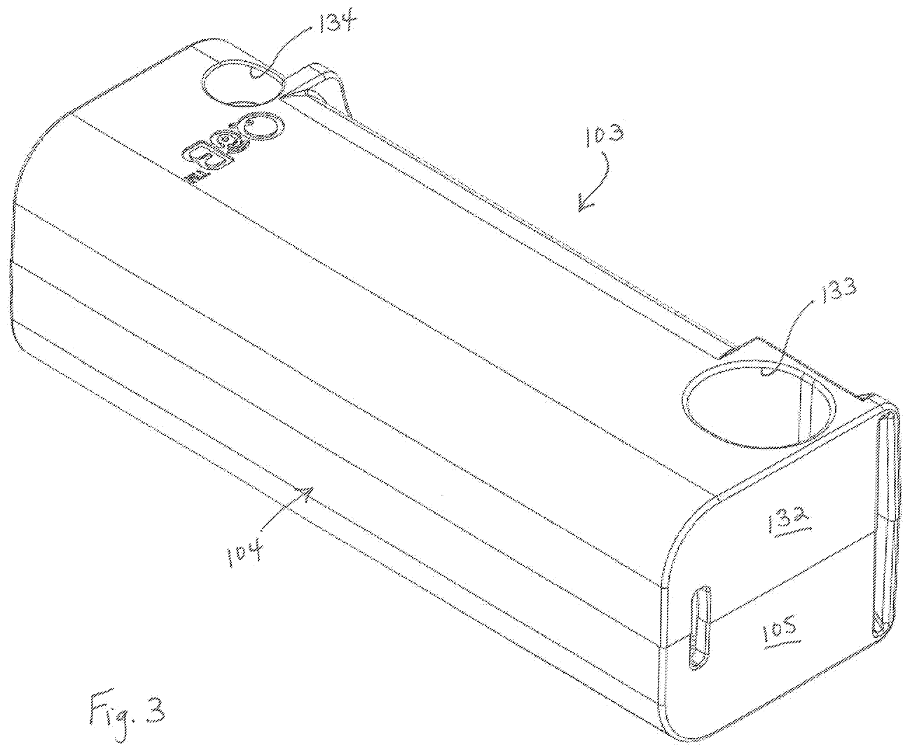

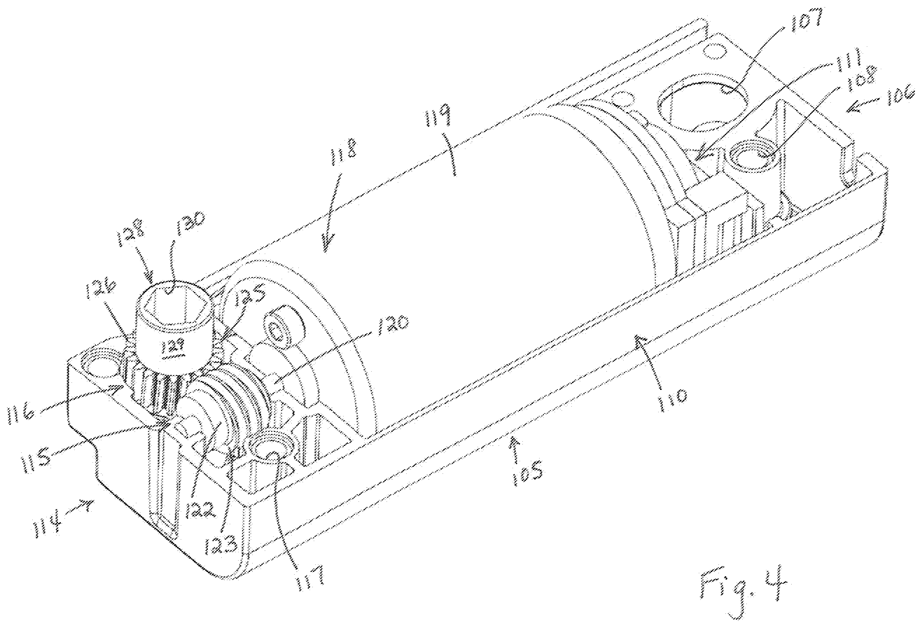

The driving member 118 can be a motor assembly 103 or any other suitable mechanism. The motor assembly 103 is preferably contained in a motor housing 104, shown in FIG. 3. As shown in FIG. 4, the motor housing 104 includes a motor housing base 105 having a first end 106, an intermediate portion 110, and a second end 114. The first end 106 includes a bore 107 and a threaded bore 108, the intermediate portion 110 forms a motor receiver 111, and the second end 114 forms a worm receiver 115 and a worm gear receiver 116 and includes a threaded bore 117. The motor receiver 111 is configured and arranged to receive a motor 119, and the motor 119 includes a rotating shaft 120 extending from the motor 119 into the worm receiver 115. Preferably, the motor 119 is positioned within the motor receiver 111 so that it “floats”, meaning that some movement is allowed within the cavity but preferably it cannot rotate. The worm receiver 115 is configured and arranged to receive a worm 122 having threading 123. The rotating shaft 120 of the motor 119 is operatively connected to the worm 122. The threading 123 mates with gear teeth 126 of a worm gear 125 positioned in the worm gear receiver 116. The worm gear 125 is preferably offset at a right angle from the motor 119. Optionally, gear grease can be used on the worm 122 and the worm gear 125. It was surprisingly found that a heavier grease reduces the sound of the motor. Examples of grease that can be used include NLGI #2 to NLGI #3 grease. In this embodiment, a motor connector 128 extends from the worm gear 125. The motor connector 128 includes a cylindrical portion 129 with a bore 130. The cylindrical portion 129 with bore 130 extends through the worm gear 125 so that opposing sides of the worm gear 125 include cylindrical portions 129 with bores 130. Although not shown, the base 105 includes a bore in communication with the bore 130. The cylindrical portion 129 includes at least one engaging feature forming at least part of the bore 130. In this embodiment, the motor housing 104 includes a motor housing cover 132 configured and arranged to engage the motor housing base 105. The motor housing cover 132 includes a bore 133 aligned and in communication with the bore 107 of the motor housing base 105 and includes a bore 134 aligned and in communication with the bore 130 of the cylindrical portion 129. The bores 107 and 133 are configured and arranged to receive a peg 176, which is preferably operatively connected to a support structure. Although not shown, the motor housing cover 132 includes threaded cylinders configured and arranged to receive fasteners 135 extending through the threaded bores 108 and 117 in the base 105 to connect the cover 132 to the base 105. Optionally, as shown in FIG. 25, foam tape 278 or any other suitable cushion member can be connected to at least part of the housing 104 to help reduce noise. Optionally, a cover made of a similar material as the support structure can be configured and arranged to receive and protect the motor assembly, and the optional foam tape 278 helps reduce noise from contacting the cover. The motor can be battery operated or hard wired to an electrical source. The motor may allow for operation of the assembly utilizing a variety of actuating sources such as, but not limited to, a wall switch, a remote control, a mobile phone app, a home security system, a HVAC system, and other types of home automation systems.

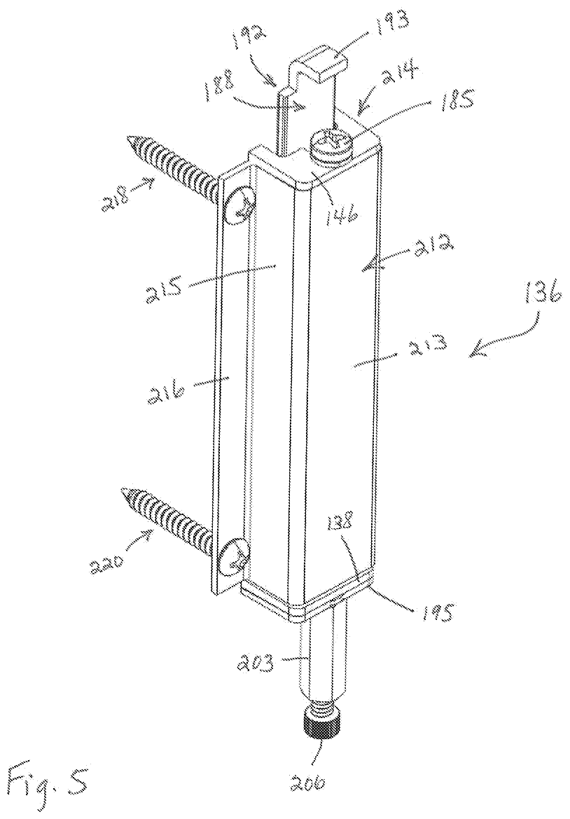

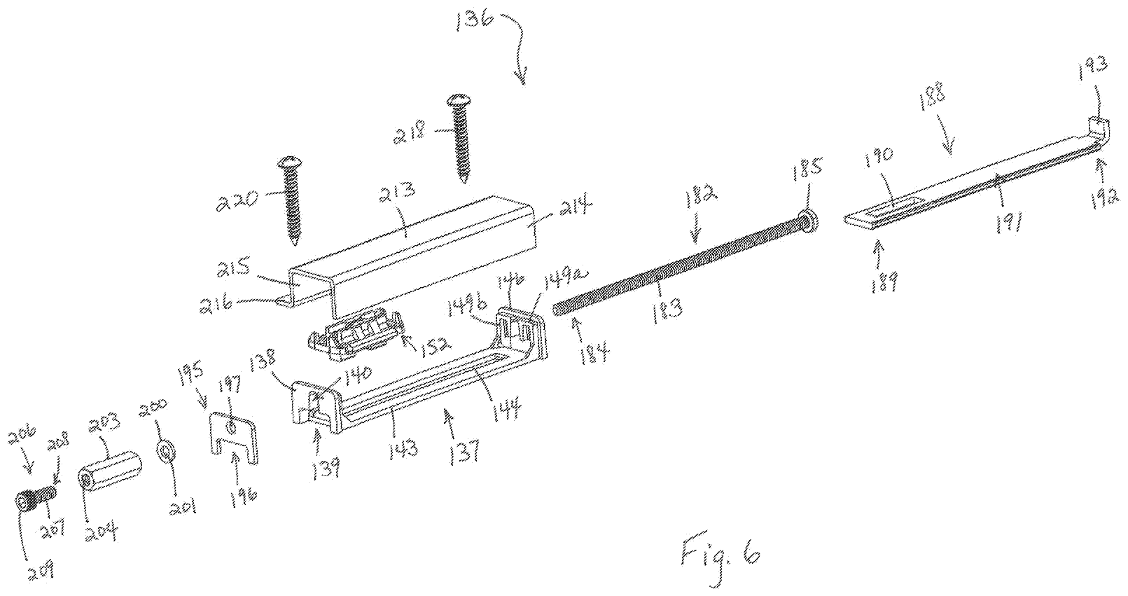

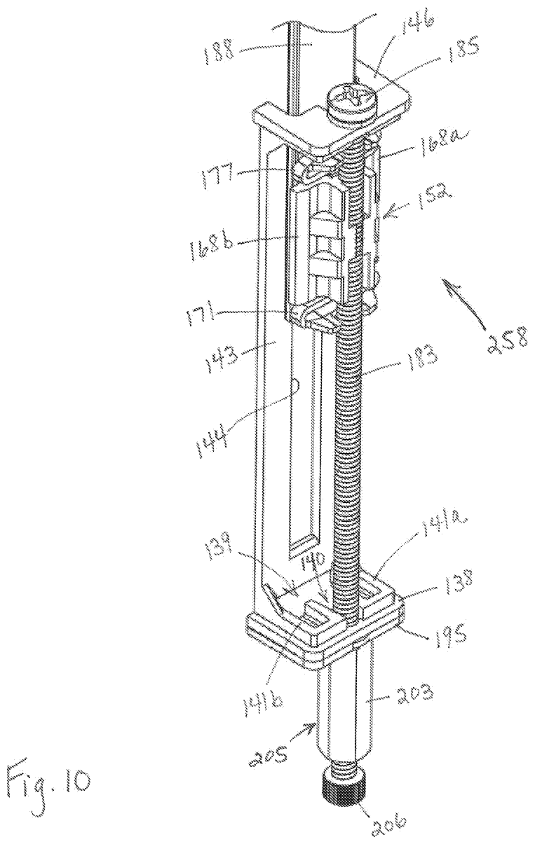

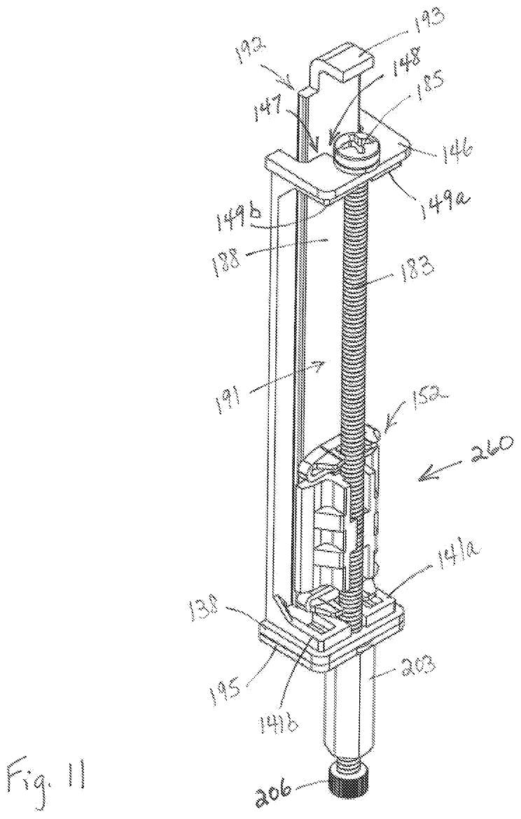

The drive assembly 136 is shown in FIGS. 5 and 6. A drive base 137 is configured and arranged to receive a lock nut 152 and a portion of a lead screw 182 extending through the lock nut 152 and the drive base 137. The drive base 137 includes a track portion 143 interconnecting a first end 138 and a second end 146. The track portion 143 includes a longitudinal slot 144 extending between the first and second ends 138 and 146. At one end of the track portion 143, the first end 138 extends outwardly from a side of the track portion 143 and includes a notch 139 proximate the track portion 143. A slot 140 extends from the notch 139. On an inner surface of the first end 138, first and second stabilizers 141a and 141b protrude from opposing sides of the slot 140. At the other end of the track portion 143, as shown in FIGS. 10 and 11, the second end 146 extends outwardly from the side of the track portion 143 and includes a notch 147 proximate the track portion 143. A slot 148 extends from the notch 147. On an inner surface of the second end 146, first and second stabilizers 149a and 149b protrude from opposing sides of the slot 148.

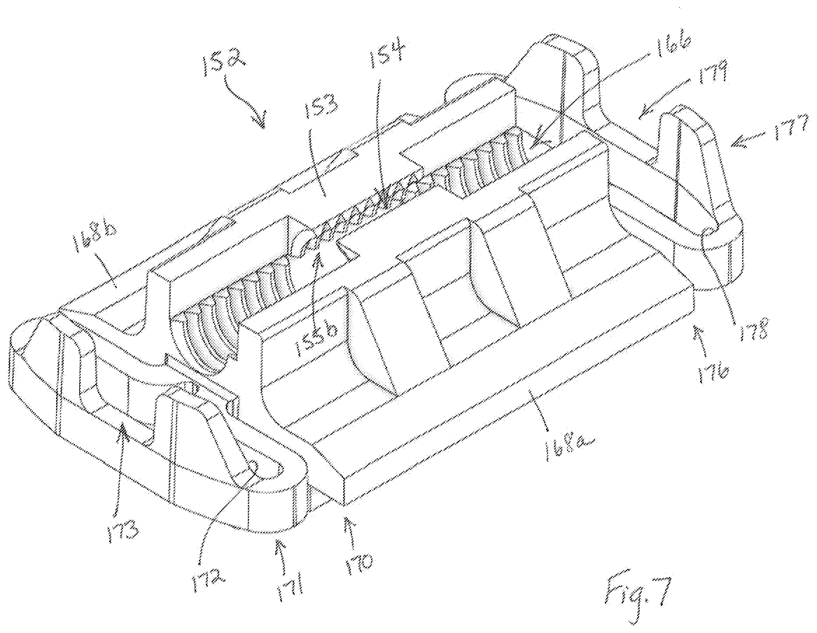

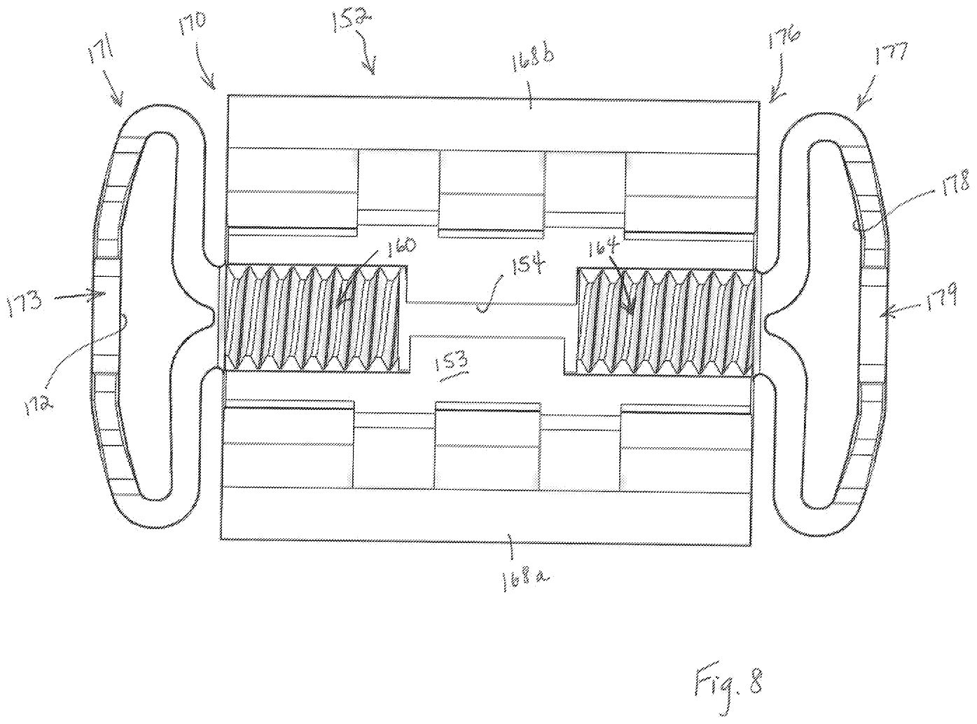

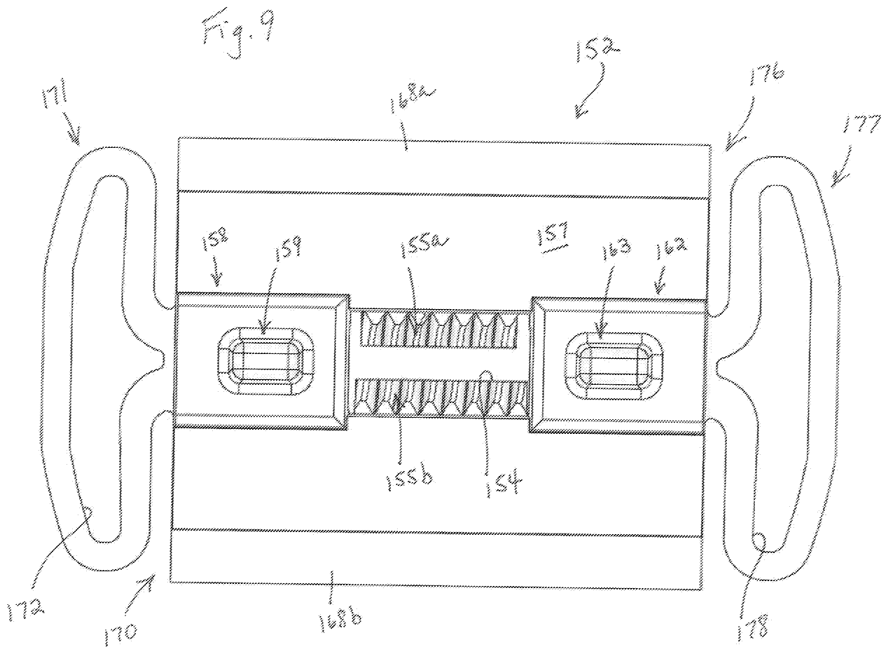

As shown in FIGS. 7-9, the lock nut 152 includes a top 153 forming a slot 154, the slot 154 forming opposing first and second threads 155a and 155b on inner surfaces of the top 153. Proximate opposing ends of the slot 154, a bottom 157 forms a first portion 158 on one end and a second portion 162 on the other end. The first portion 158 includes a first protrusion 159 on its outer surface and first portion threads 160 on its inner surface. The second portion 162 includes a second protrusion 163 on its outer surface and second portion threads 164 on its inner surface. A bore 166 is formed by the first portion 158, the top 153, and the second portion 162. First and second flanges 168a and 168b extend from opposing sides of the top 153 toward the bottom 157. First and second springs 171 and 177 extend outward from first and second ends 170 and 176 of the lock nut 152. Generally, the first and second springs 171 and 177 are loops forming openings 172 and 178, respectively, extending outward from the respective ends. Preferably, the tops of the first and second springs 171 and 177 include opposing extensions forming notches 173 and 179.

A connector 188 is operatively connected to the lock nut 152. The connector 188 is a generally rectangular plate member with a first end 189 including a longitudinal slot 190 and a second end 192 with a tab 193 protruding outwardly therefrom. The longitudinal slot 190 is configured and arranged to receive the first and second portions 158 and 162 from the lock nut 152, and the flanges 168a and 168b are configured and arranged to contact the first end 189 on opposing sides of the slot 190, as shown in FIG. 10 for example. Although a lock nut 152 is used in this embodiment, any suitable carriage could be used.

With the connector 188 operatively connected to the lock nut 152, the first and second protrusions 159 and 163 from the lock nut 152 are configured and arranged to fit within the slot 144 of the drive base 137, with a portion of the connector 188 sandwiched between the lock nut 152 and the track portion 143. The lead screw 182 includes a threaded shaft 183 with a head 185 and a distal end 184. The lead screw 182 extends through the slot 148 in the second end 146 of the drive base 137, with the head 185 positioned proximate the second end 146, through the notch 179 in the second spring 177, through the bore 166 of the lock nut 152, through the notch 173 in the first spring 171, and through the slot 140 in the first end 138 so that the distal end 184 extends out from the first end 138. As shown in FIG. 11, the slots 140 and 148 in the first and second ends 138 and 146 of the lock nut 152 are configured and arranged to receive portions of the lead screw 182 and the stabilizers 141a, 141b, 149a, and 149b are configured and arranged to provide support for the lead screw 182. The notches 139 and 147 are configured and arranged to receive portions of the connector 188.

A plate 195 generally corresponds with the first end 138, with a notch 196 corresponding with the notch 139 and an aperture 197 corresponding with the top of the slot 140. The distal end 184 of the lead screw 182 extends through the aperture 197, through an aperture 201 of a washer 200, and into a threaded bore 204 of a drive connector 203. The outer surface of the drive connector 203 includes at least one engaging feature. In this example, the drive connector 203 has a hex-shaped exterior. A lock fastener 206 includes a head 209 connected to a shaft 207 with a distal end 208. The distal end 208 of the lock fastener 206 is inserted into the threaded bore 204 of the drive connector 203 opposite the lead screw 182, and the distal ends 184 and 208 contact each other within the threaded bore 204. Lead screw 182 can handle more force when the load is supported to maintain tensile forces in the lead screw 182. The operating load is transferred from the connector 188 to the carriage 152 and to the lead screw 182 through the previously described threaded connection between the lead screw 182 and the carriage 152. The force carried by the lead screw 182 is transmitted to the drive base 137 by the head 185 during the locking motion. The force carried by the lead screw 182 is transmitted to the drive base 137 by the drive connector 203 during the unlocking motion. This combination of supports for the forces puts the lead screw 182 in tension during either the locking motion or the unlocking motion. Because the lead screw 182 is in tension, it is stronger and, therefore, a thinner diameter shaft can be used that requires less torque to rotate. For example, a #6 or #632 screw could be used. Also, the lead screw 182 in tension helps reduce noise during operation.

Preferably, a drive cover 212 is operatively connected to the drive base 137. A top 213 is configured and arranged to interconnect the first and second ends 138 and 146 of the drive base 137, with the top 213 resting on the stabilizers 141a, 141b, 149a, and 149b between the first and second ends 138 and 146; and first and second sides 214 and 215 extend from the top 213 to the track portion 143. A flange 216 extends outward from the second side 215 and includes apertures 217 and 219 through which fasteners 218 and 220 extend to secure the drive cover 212 to the support structure. Preferably, the drive cover 212 is metal (e.g., steel) to add strength to the drive base 137 that is preferably plastic.

The tab 193 of the connector's second end 192 is configured and arranged to extend through a slot 226 in a first end 225 of an elongate member or lock bar 224. In this embodiment, the first end 225 of the lock bar 224 includes a protrusion 227 with a head 228, an intermediate portion 230 of the lock bar 224 optionally includes a protrusion 231 with a head 232, and a second, distal end 234 of the lock bar 224 includes a protrusion 235 with a head 236.

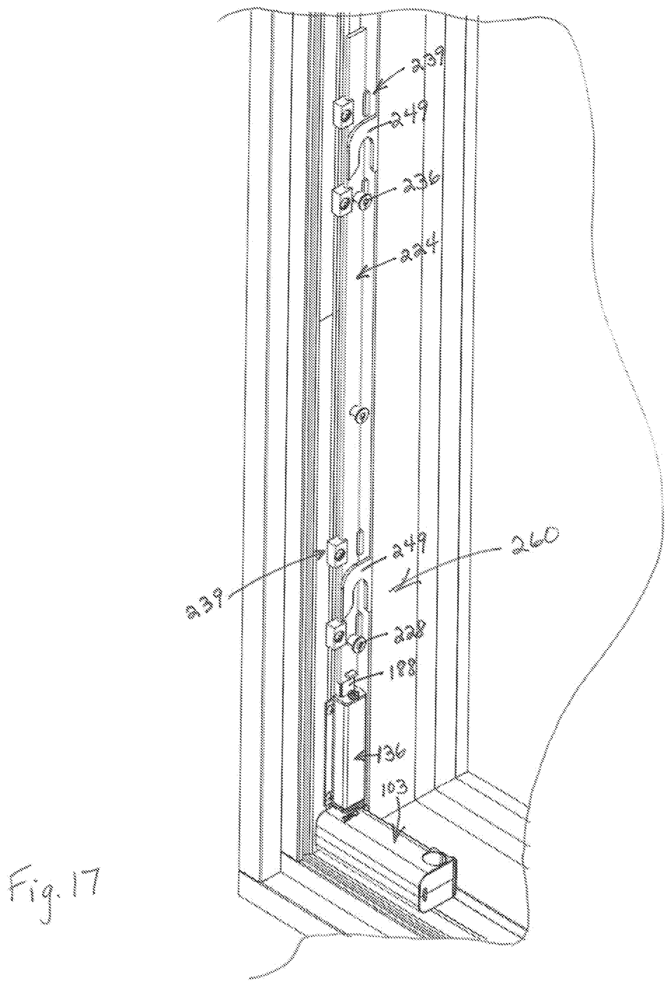

Preferably, a plurality of guides 239 are positioned along the support structure to slidably receive and support the lock bar 224. In this embodiment, the guide 239 is generally U-shaped with a back 240 interconnecting first and second arms 241 and 242, which include inwardly extending distal portions forming an opening that is narrower than a channel formed by the back 240 and the first and second arms 241 and 242. The channel is configured and arranged to slidably receive the lock bar 224 while the opening 244 allows the protrusions extending from the lock bar 224 to move therethrough, as shown for example in FIG. 17. The second arm 242 includes an aperture (not shown) configured and arranged to receive a fastener 246 to secure the guide 239 to the support structure.

An engaging member 249 is operatively connected to a second support structure and is configured and arranged to selectively engage the respective protrusion on the lock bar 224. In this embodiment, the engaging member 249 is generally hook shaped including a connector portion 250, which includes apertures 251 and 252 through which fasteners (not shown) extend to secure it to the second support structure, and a hook portion 253 that forms an opening 254 configured and arranged to receive the protrusion on the lock bar 224.

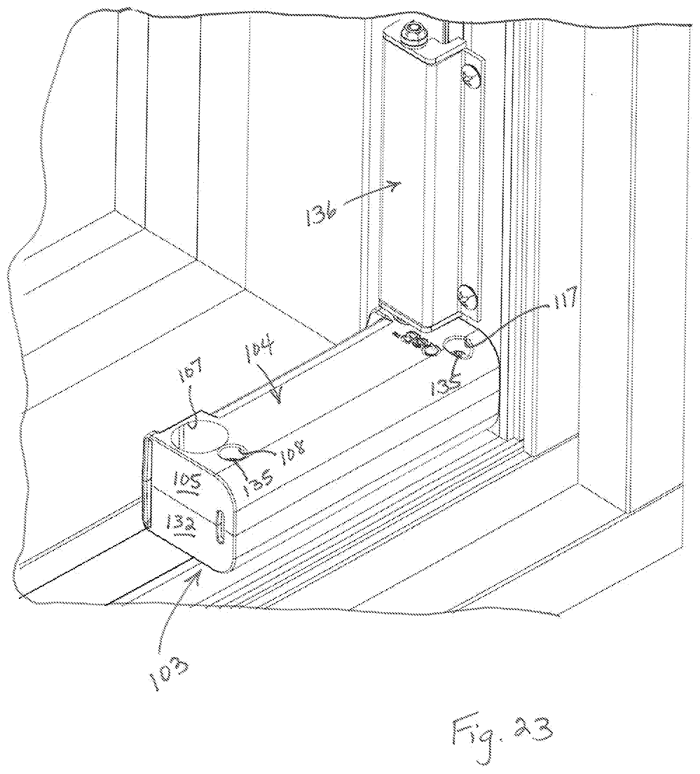

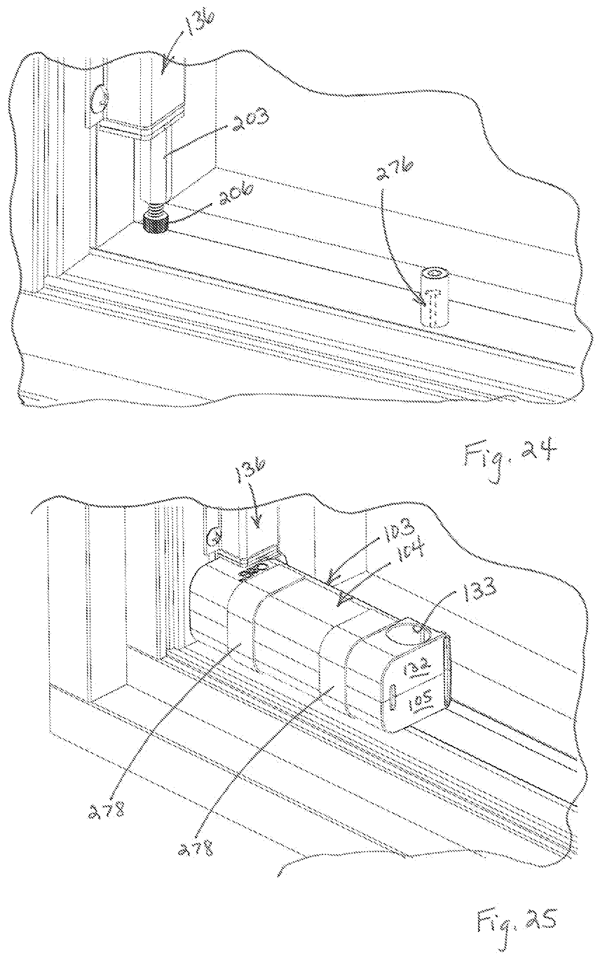

The lock assembly 100 is operatively connected to support structure(s) or mounting surface(s). For example, as shown in FIG. 24, a peg 276 is preferably mounted on a horizontal surface and, as shown in FIG. 25, the motor assembly 103 is positioned so that the peg 276 is positioned within the bores 107 and 133 of the housing 104. The fit of the peg 276 is loose to allow the motor to rotate and translate as needed for self-centering on the drive end. To reduce noise, the peg 176 is preferably a standing screw with a foam tube. Once the motor assembly 103 is thus positioned, then the drive assembly 136 is positioned so that the drive connector 203 is positioned within the bore 130 of the motor connector 128. Then the drive assembly 136 is connected to a vertical surface as previously described. The lock assembly 100 is preferably universal or un-handed, meaning it can be mounted on either side of the support structure (e.g., window). As shown in FIG. 23, the motor housing 104 can be simply flipped upside down so that the cover 132 is on the bottom and the base 105 is on the top.

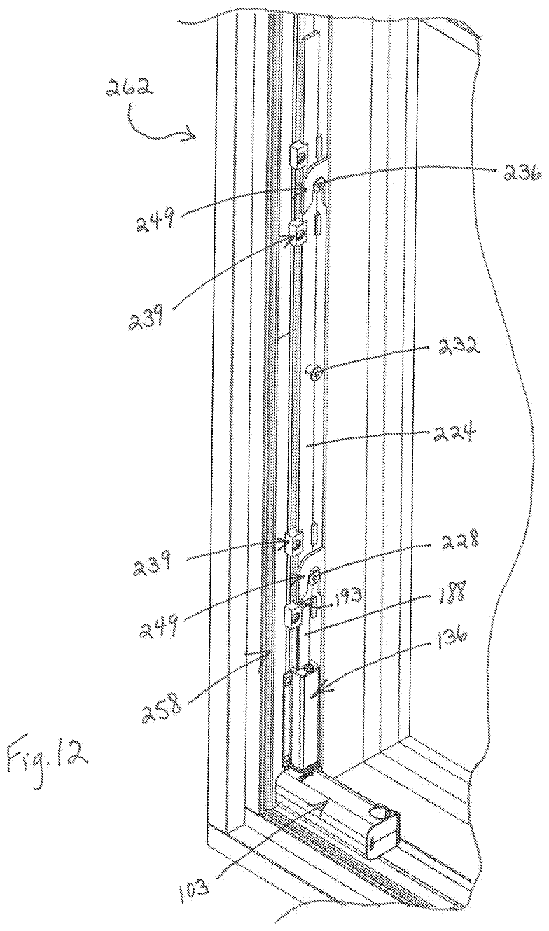

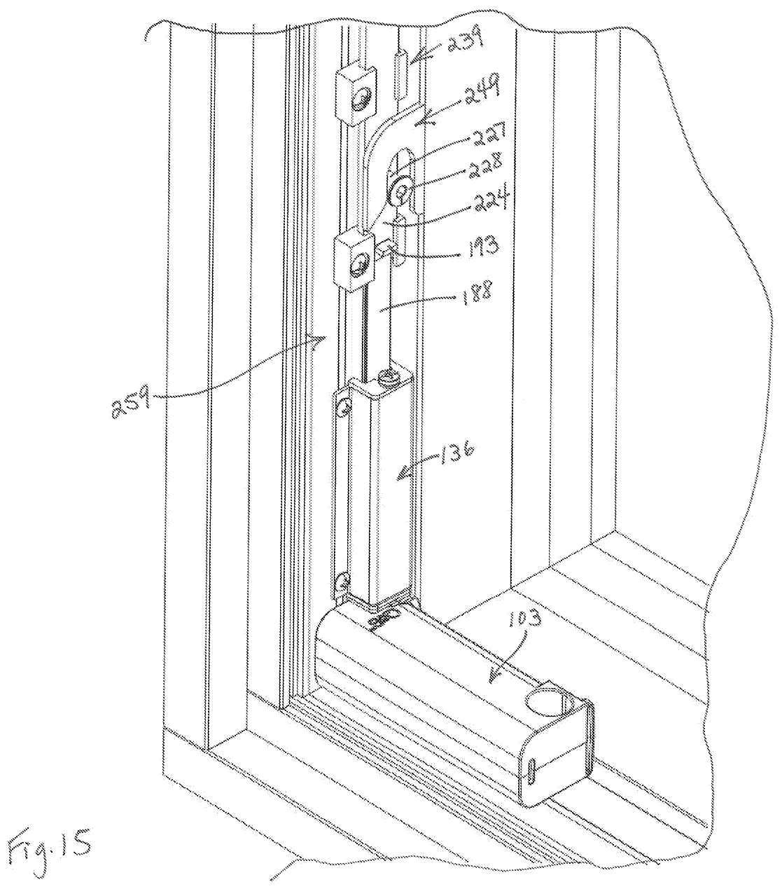

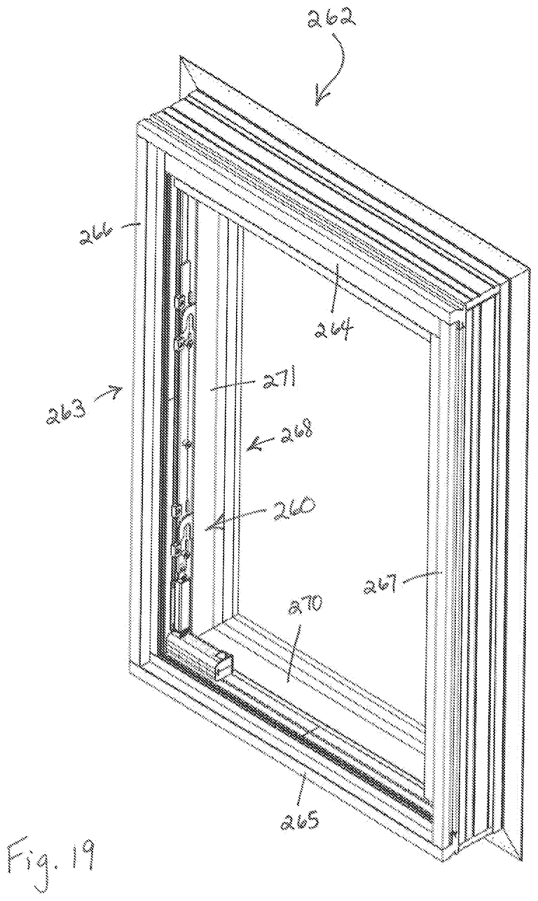

The lock assembly 100 is shown operatively connected to a window 262 in FIGS. 12-22. The window 262 includes a frame 263 to which a sash 268 is operatively connected with a hinge 273 for relative movement between open and closed positions. For example, the sash 268 may be moved in a controlled manner relative to the window frame 263 such that the sash 268 pivots, pivots and translates, pivots and slides, rotates, or otherwise moves relative to the window frame 263. Movement of at least one operator assembly opens or closes the sash 268 relative to the window frame 263. The hinge 273 interconnects the frame 263 and the sash 268, and the hinge 273 controls the path of the sash 268 with respect to the frame 263, and the window operator assembly positions the sash 268 along the path by changing the distance between a sash pivot and a frame pivot. The frame 263 includes a top member 264 and a bottom member 265 interconnected on one side by a first side member 266 and on the other side by a second side member 267. Similarly, the sash 268 includes a top member 269 and a bottom member 270 interconnected on one side by a first side member 271 and on the other side by a second side member 272. A window operator (not shown) is configured and arranged to move the sash 268 (a movable member) relative to the frame 263 (a stationary member). The sash 268 is shown in several possible positions relative to the frame 263 in FIGS. 19-22. One or both of top and bottom operator assemblies may be used. For larger windows, using both the top operator assembly and the bottom operator assembly adds strength and stability to the system and makes it easier to open and close the sash. For smaller windows, an operator assembly may be positioned on either the top member 264 or the bottom member 265 of the window frame 263.

In operation, when it is desired to lock or unlock support structures relative to one another (e.g., a stationary member (window frame) relative to a movable member (window sash)), a driving member is activated to rotate a drive assembly. The driving member is configured and arranged to rotate the drive connector 203, which rotates the lead screw 182 relative to the drive base 137. If the driving member is the motor assembly 103, the motor 119 rotates the motor shaft 120, which rotates the worm 122, which rotates the worm gear 125 and associated motor connector 128. The motor connector 128 receives the drive connector 203 so rotation of the motor connector 128 rotates the drive connector 203 and the lead screw 182. As the lead screw 182 rotates, the carriage (lock nut 152) moves along the shaft 183 of the lead screw 182 thereby moving the elongate member (lock bar 224).

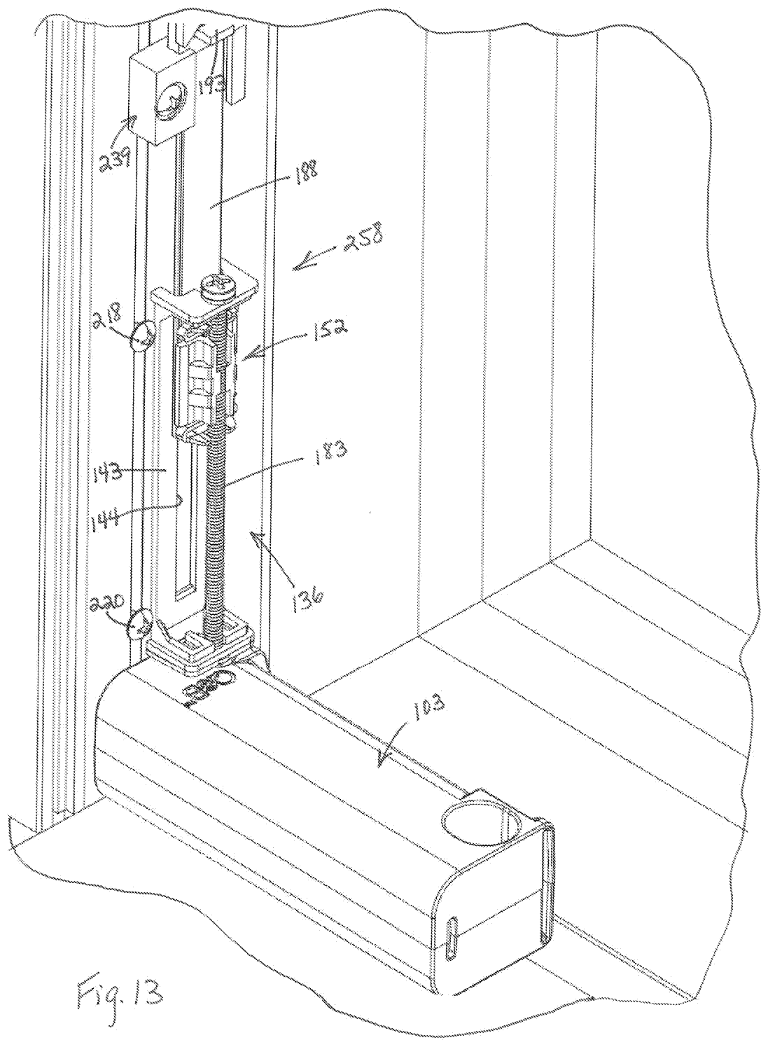

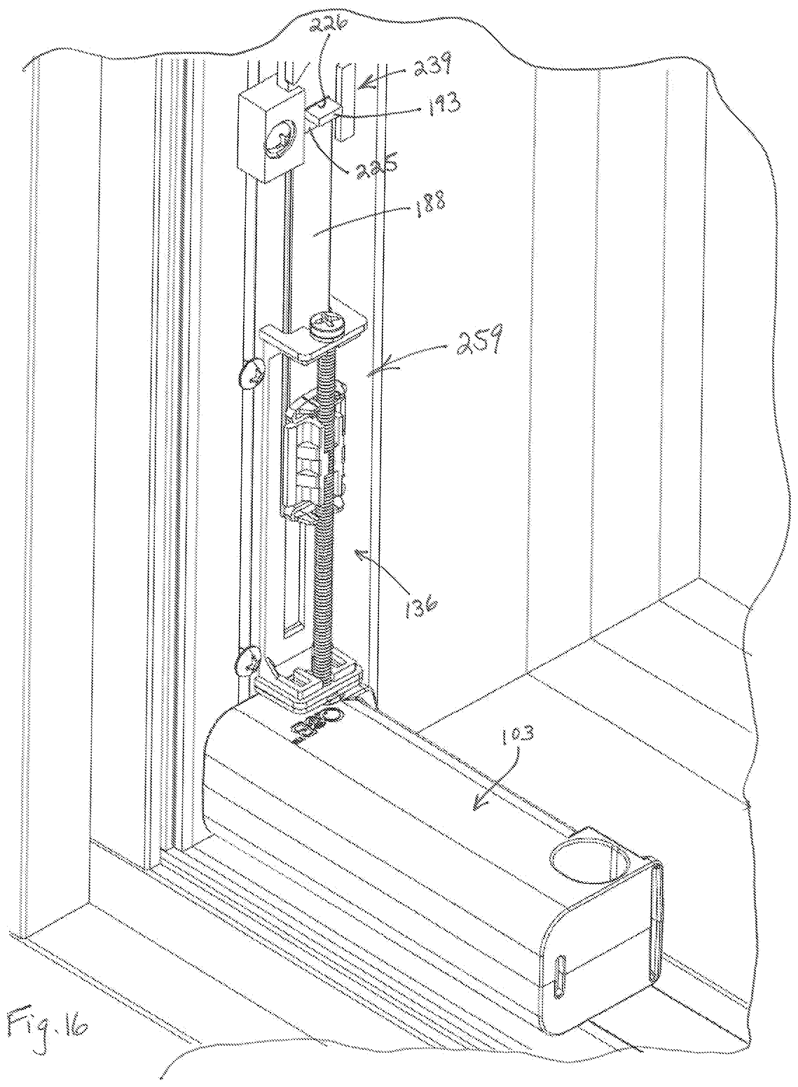

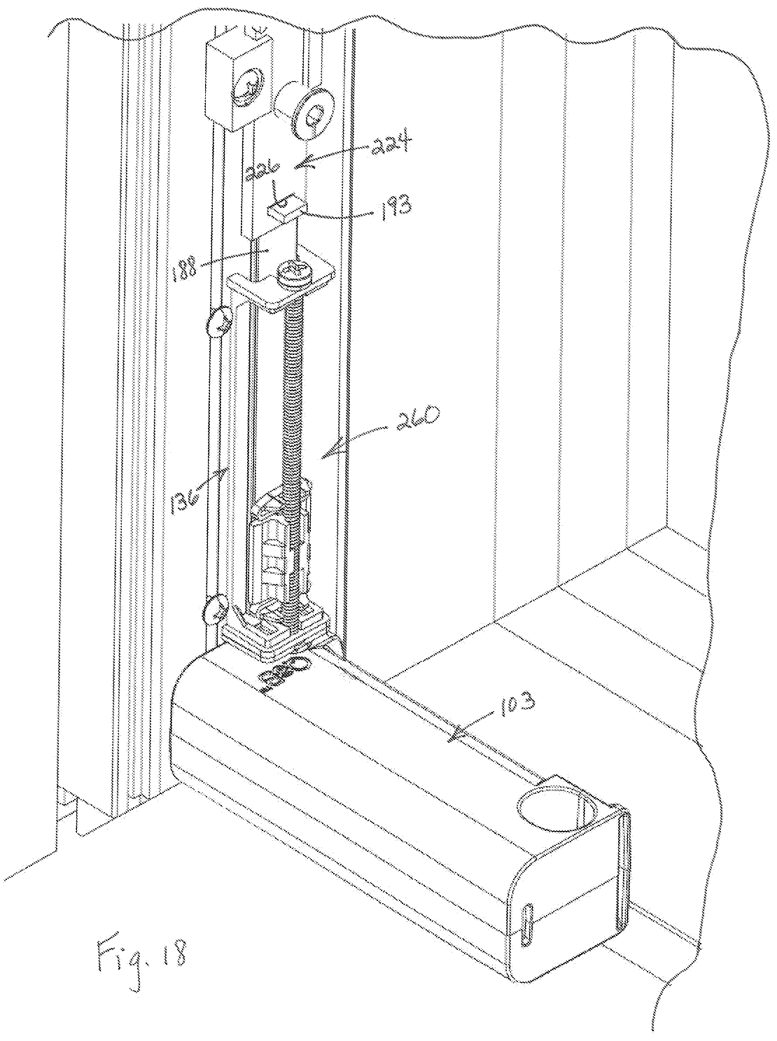

If the lead screw 182 is rotated in a first direction, the lock nut 152 moves toward the distal end 184 of the lead screw 182 thereby moving the lock bar 224 toward a locked position 258, which is shown in FIGS. 10 and 13. If the lead screw 182 is rotated in a second, opposite direction, the lock nut 152 moves toward the head 185 of the lead screw 182 thereby moving the lock bar 224 toward an unlocked position 260, shown in FIGS. 11 and 18. As the lock nut 152 moves between the locked and unlocked positions, it is in a plurality of intermediate positions, such as intermediate position 259 shown in FIG. 16. The intermediate positions could include partially locked and partially unlocked positions. The springs 171 and 177 on the ends of the lock nut 152 assist in preventing sudden, hard stops of the lock nut 152, and provide energy absorption, as the springs 171 and 177 contact the respective ends 138 and 146 of the drive base 137 to help prevent binding. The resistance provided by the springs 171 and 177 also signals the end of travel to stop rotation of the motor assembly 103.

When the movable member or window sash is in the closed position and the lock nut 152 is moved into the locked position, the engaging member 249 receives the respective protrusion. If a proximity sensor is used, the lock nut 152 will not be moved into the lock position unless the movable member or window sash is in the closed position relative to the stationary member or window frame. After the lock nut 152 is positioned in the locked position, the motor is preferably backed up to reduce the load on the lock assembly.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A lock assembly, comprising:
a driving member;
a drive assembly comprising a drive connector operatively connected to the driving member, a lead screw operatively connected to the drive connector, a carriage configured and arranged to move along the lead screw, and an elongate member operatively connected to the carriage, wherein the driving member is configured and arranged to rotate the drive connector, the drive connector is configured and arranged to rotate the lead screw, wherein rotation of the lead screw moves the carriage along the lead screw and the elongate member moves with the carriage between locked and unlocked positions; and
an engaging member configured and arranged to selectively engage the elongate member in the locked position.

2. The lock assembly of claim 1, wherein the driving member, the drive assembly, and the engaging member are universal.

3. The lock assembly of claim 1, wherein the driving member is a motor assembly comprising a motor operatively connected to a motor gear assembly, the motor configured and arranged to rotate the motor gear assembly and the motor gear assembly configured and arranged to rotate the drive connector.

4. The lock assembly of claim 3, wherein the motor gear assembly includes a worm, a worm gear, and a motor connector, and wherein the motor is configured and arranged to rotate the worm, the worm is configured and arranged to rotate the worm gear, and the worm gear is configured and arranged to rotate the motor connector.

5. The lock assembly of claim 4, wherein the motor connector includes a bore having at least one engaging feature, the bore being configured and arranged to receive the drive connector, the at least one engaging feature being configured and arranged to prevent rotation of the drive connector within the bore.

6. The lock assembly of claim 5, wherein the drive connector includes at least one mating engaging feature configured and arranged to engage the at least one engaging feature of the motor connector.

7. The lock assembly of claim 6, wherein the at least one engaging feature and the at least one mating engaging feature are complementary hex-shapes.

8. The lock assembly of claim 1, wherein the drive assembly is configured and arranged to be mounted to a stationary portion and the elongate member includes a protrusion configured and arranged to be selectively engaged by the engaging member mounted to a movable portion, wherein the engaging member engages the protrusion to secure the movable portion to the stationary portion in the locked position.

9. The lock assembly of claim 8, wherein the movable portion is a window sash and the stationary portion is a window frame.

10. The lock assembly of claim 1, wherein the carriage includes a first spring operatively connected to a first end and a second spring operatively connected to a second end.

11. The lock assembly of claim 1, further comprising a motor housing including an oblong opening configured and arranged to allow the motor housing to float.

12. The lock assembly of claim 1, wherein the drive connector is secured onto the lead screw.

13. The lock assembly of claim 12, wherein the drive connector includes a threaded bore, a lock fastener being threaded into a first end of the threaded bore and the lead screw being threaded into a second end of the threaded bore, the distal ends of the lock fastener and the lead screw being in contact thereby putting the lead screw in tension.

14. A lock assembly, comprising:
a motor assembly comprising a motor operatively connected to a motor gear assembly, the motor gear assembly including a worm, a worm gear, and a motor connector, wherein the motor is configured and arranged to rotate the worm, the worm is configured and arranged to rotate the worm gear, and the worm gear is configured and arranged to rotate the motor connector;
a drive assembly comprising a drive connector operatively connected to the motor connector, a lead screw operatively connected to the drive connector, a carriage configured and arranged to move along the lead screw, and an elongate member operatively connected to the carriage, wherein the motor connector is configured and arranged to rotate the drive connector, the drive connector is configured and arranged to rotate the lead screw, wherein rotation of the lead screw moves the carriage along the lead screw and the elongate member moves with the carriage between locked and unlocked positions; and
an engaging member configured and arranged to selectively engage the elongate member in the locked position.

15. The lock assembly of claim 14, wherein the driving member, the drive assembly, and the engaging member are universal.

16. The lock assembly of claim 14, wherein the drive assembly is configured and arranged to be mounted to a window frame and the elongate member includes a protrusion configured and arranged to be selectively engaged by the engaging member mounted to a window sash, wherein the engaging member engages the protrusion to secure the window sash to the window frame in the locked position.

17. The lock assembly of claim 14, wherein the carriage includes a first spring operatively connected to a first end and a second spring operatively connected to a second end.

18. The lock assembly of claim 14, wherein the lead screw is in tension.
